(19) United States
(12) Patent Application Publication
(10) Pub. No.: US 2023/0280713 A1
(43) Pub. Date: Sep. 7, 2023

(54) METHOD AND APPARATUS FOR CONFIGURING AN INDUSTRIAL CONTROL APPARATUS

(71) Applicant: WAGO Verwaltungsgesellschaft mbH, Minden (DE)

(72) Inventors: Klaus HUEBSCHLE, St. Georgen (AT); Achim FECKE, Porta Westfalica (DE); Sven KREFT, Enger (DE)

(73) Assignee: WAGO Verwaltungsgesellschaft mbH, Minden (DE)

(21) Appl. No.: 18/196,784

(22) Filed: May 12, 2023

Related U.S. Application Data
(63) Continuation of application No. PCT/EP2021/081391, filed on Nov. 11, 2021.

(30) Foreign Application Priority Data
Nov. 12, 2020 (DE) 10 2020 214 242.4

(51) Int. Cl. G05B 19/05

(52) U.S. Cl. CPC G05B 19/052; G05B 2219/15012; G05B 2219/23115

(57) ABSTRACT

A method for configuring an industrial control apparatus, the method including: starting a detection mode; selecting a stock control apparatus; opening a stock configuration of the stock control apparatus; selecting and buffer-storing at least one feature of the stock configuration; starting a transfer mode; selecting at least one target control apparatus; and transferring the at least one selected and buffer-stored feature of the stock configuration to the target control apparatus.

This nonprovisional application is a continuation of International Application No PCT/EP2021/081391, which was filed on Nov. 11, 2021, and which claims priority to German Patent Application No 10 2020 214 242.4, which was filed in Germany on Nov. 12, 2020, and which are both herein incorporated by reference.

### BACKGROUND OF THE INVENTION

### Field of the Invention

The present invention relates to a method and an apparatus for configuring an industrial control apparatus, particularly programmable logic controllers, for industrial automation technology.

### Description of the Background Art

Industrial control apparatuses, such as programmable logic controllers, are used, for example, to automate industrial processes or to control and regulate functions in building automation or vehicle automation.

In the engineering of automation systems, the industrial control apparatuses are programmed and configured by means of engineering software. This involves the programs and parameter data, variables or other data, which are generally referred to herein as features, being transferred to the hardware of the industrial control apparatus, which then performs the control tasks on the basis of these programs.

On the one hand, the engineering process is time-consuming and error-prone, because it usually requires many manual inputs from a system developer. There is, therefore, a need to make the engineering more efficient, reduce the time required and minimize the error rate.

### SUMMARY OF THE INVENTION

It is therefore an object of the present invention to provide a method for configuring an industrial control apparatus, as well as an apparatus for the implementation of the method.

In an exemplary embodiment, the above object is achieved by a method for configuring an industrial control apparatus having the following steps: starting a detection mode; selecting a stock control apparatus; opening a stock configuration of the stock control apparatus; selecting and buffer-storing at least one feature from the stock configuration; starting a transfer mode; selecting at least one target control apparatus; and transferring the at least one selected and buffer-stored feature of the stock configuration to the target control apparatus.

The transfer of stock configurations can be carried out efficiently by means of the inventive method on any number of stock control apparatuses. Therefore, the configuration of the target control apparatus or target control apparatuses does not need to be completely recreated. Instead, the system developer can draw on empirical knowledge or known stock configurations. By buffer-storing at least one feature from the existing stock configuration and automatically transferring it to the correct location in the target configuration of the target control apparatus, the time required and the error rate during the engineering process with regard to the configuration and parameterization of control apparatuses is reduced. Manual entries are reduced to the bare minimum, thus significantly reducing the error rate. The selection of transferable features of the stock configuration allows not only for the creation of copies of control apparatus configurations, but also the targeted selection of the features to be transferred in order to configure the target control apparatus individually. This means that all identical features can be selectively transferred to the target configuration of the target control apparatus with the help of the program, wherein the non-identical features do not require transfer. These non-identical features remain at their previous value in the target control apparatus. In this case, the stock configurations can originate from projected stock control apparatuses and also from those that have already been implemented.

Preferably, the step of starting a transfer mode involves scanning one or more networks for stock control apparatuses and / or for target control apparatuses. This makes it possible to identify already configured, existing stock control apparatuses in the accessible networks and then access their stock configuration. Furthermore, control apparatuses which are already installed on the hardware can be identified as still needing to be configured and are therefore potential target control apparatuses.

Preferably, the stock control apparatuses and / or the target control apparatuses may be located in a common network or in multiple different networks. By means of appropriate interfaces, it is possible for the computer with the configuration software to access multiple different networks in which control apparatuses are located, simultaneously or one after the other. Therefore, a cross-network and remote configuration of industrial control apparatuses can be carried out, wherein the empirical knowledge of all stock control apparatuses of a company can be accessed, for example. This also means that it is not necessary for the system developer to be on site to configure a control apparatus installed on the hardware. Rather, the configuration process can be performed completely remotely.

Preferably, the method for configuring an industrial control apparatus also includes the step of exiting the detection mode. This actively completes the detection mode and the engineering of the control apparatus can be continued at will, retaining the buffer-stored features for a later date.

Preferably, the steps of starting to detecting are repeated for more than one stock control apparatus in order to select features from different stock configurations of different stock control apparatuses. This makes it possible to compile the desired configuration from the stock configurations of multiple stock control apparatuses. This compilation of the desired configuration from multiple stock control apparatuses can preferably be done before transfer to the target control apparatus.

Preferably, the features from different stock configurations are transferred to the target control apparatus in a single transfer step. This increases the efficiency of engineering, as it means that there is less of a need to switch back and forth between the existing and target control apparatuses as frequently.

Preferably, more than one target control apparatus is selected in the selecting step and in the transferring step, at least one selected and buffer-stored feature of the stock configuration is transferred to each of the selected target control apparatuses. This allows for at least one feature or multiple buffer-stored features to be transferred to multiple target control apparatuses in one operation, further improving engineering efficiency.

The steps of selecting and transferring can be repeated for multiple target control apparatuses. This means that one or more further target control apparatuses with the same features can be configured even after a previous transfer of features to a target control apparatus.

The method can also include the step of displaying the selected feature or features. This makes the transfer of the features clearer and more comprehensible to the user.

The step of displaying the selected features can take place before the transfer of the features to the target control apparatus. This allows for the user to see which features are transferred to the target control apparatus before the transfer. This is particularly advantageous when the detection of the features to be transferred occurred a while back. This measure also serves to ensure clarity and improves the error rate of engineering.

The step of displaying the selected features can take place after the steps of selecting and transferring. This allows for the user to see which features are transferred to the target control apparatus immediately before the transfer.

Also, after step the step of selecting and before the step of transferring, a step of selecting the features to be transferred to the target control apparatus from the buffer-stored features is possible. This allows for the user to select or deselect the features to be buffer-stored for actual transfer to the target control apparatus.

Further, after the step of selecting and before the step of transferring, a step of manual modification of the buffer-stored features is possible. This further increases the efficiency of engineering, as manual adjustment of features to be transferred is already possible during the program supported transfer of configurations. This eliminates the need for separate setting or modification of non-identical features at a later date, which would result in increased engineering effort.

The above-mentioned objects are further achieved by an apparatus for carrying out the above-mentioned method.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic view of an automation system having multiple stock and target control apparatuses and a buffer-store for features to be transferred; and

FIG. 2 is a flow chart of an embodiment of the method according to the invention for configuring an industrial control apparatus.

### DETAILED DESCRIPTION

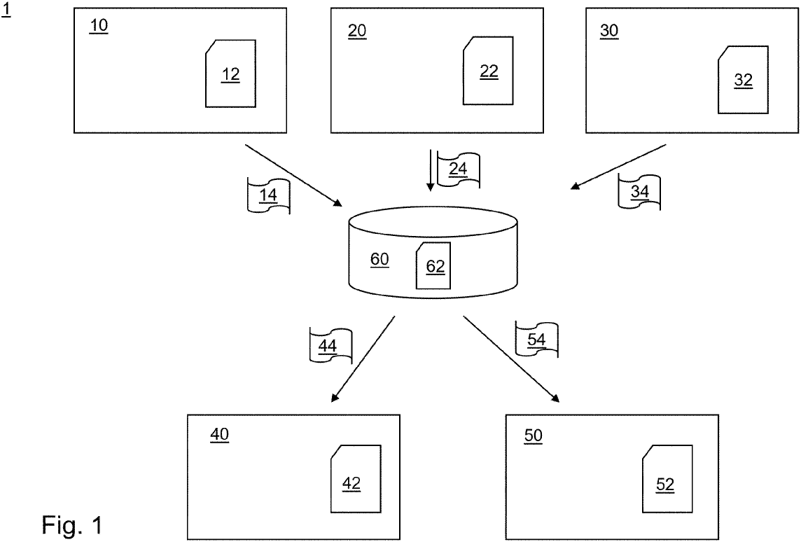

FIG. 1 shows a schematic view of an automation system 1 with three exemplary stock control apparatuses 10, 20, 30 and two target control apparatuses 40, 50 as well as a buffer-store 60 for features to be transferred. The stock control apparatuses 10, 20, 30 and target control apparatuses 40, 50 may be, for example, a controller, programmable logic controllers, or other programmable or parameterizable components of an automation system 1.

The stock control apparatuses 10, 20, 30 are preferably already fully configured and ready for use. Therefore, their memory contains features of their stock configurations 12, 22, 32, such as programs, parameter data, variables or other data that enable a program sequence.

In the example of FIG. 1, the target control apparatuses 40, 50 have been added to the automation system 1 and are now to be configured, i.e., their respective target configuration 42, 52 is to be created. Such a configuration or engineering of the target control apparatuses 40, 50 can be carried out by means of engineering software with which the features of the target configurations 42, 52, such as programs and other data, are created and stored in the memory of the target control apparatuses 40, 50. Programming or parameterization can usually be done manually by a user, such as a system developer. This activity is now mechanically supported by the system 1 and the method 100.

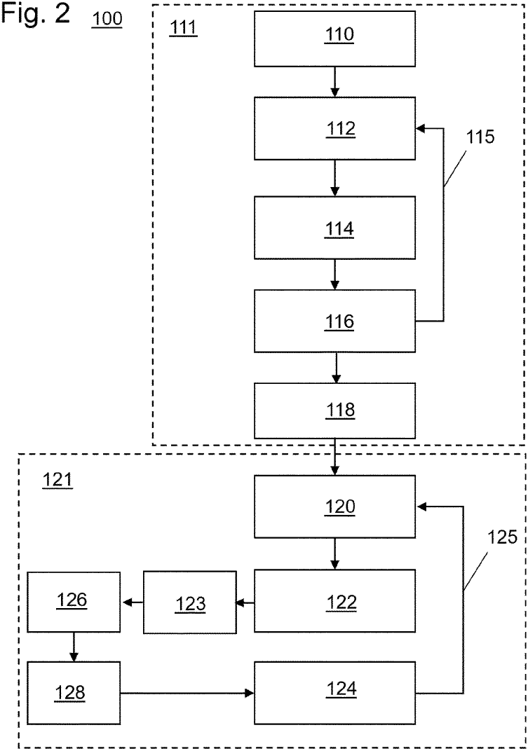

FIG. 2 shows a flow chart of a corresponding method 100 for configuring the target control apparatuses 40, 50. In this case, the user starts the detection mode 111 in step 110 in an engineering program, with which features can be read out from at least one stock control apparatus 10, 20, 30.

At the beginning of the planning process in starting step 110, it is preferable to establish a connection between the computer on which the engineering program runs and one or more stock control apparatuses 10, 20, 30, which are located in a common or in multiple separate networks. The computer of the engineering program itself is located either in the same network or in a separate network and can connect to the multiple networks via appropriate interfaces.

After the connection has been established, the engineering program scans one or more selected networks in step 110 at the start of the detection mode 111 for already projected or implemented stock control apparatuses 10, 20, 30 and / or after target control apparatuses 40, 50 that have not yet been configured or have yet to be fully configured.

Afterwards, in step 112, the user selects a stock control apparatus 10, 20, 30 from the identified stock control apparatuses 10, 20, 30, from which said user wishes to transfer features of the stock configuration 12, 22, 32. This selection can be made by clicking on a corresponding icon of the stock control apparatus 10, 20, 30 or by selecting from a displayed list or by similar means.

Once selected, the engineering program opens the corresponding stock configuration 12, 22, 32 of the selected stock control apparatus 10, 20, 30. In this case, the engineering program preferably contacts the selected stock control apparatus 10, 20, 30 and loads the corresponding stock configuration 12, 22, 32 into the engineering program.

The open features of the stock configuration 12, 22, 32 are displayed to the user, to select at least one of the features in step 116. The selected features are then loaded as data packets 14, 24, 34 in a buffer-store 60 and buffer-stored there.

After this step 116, the user can end the detection mode 111 with a step 118 or select another stock control apparatus 10, 20, 30 from which further features are to be transferred, as shown by the arrow 115. For example, if the user first selects features from the stock configuration 12 of the stock control apparatus 10 for buffer-storing, the user can now, for example, additionally add features from the stock configuration 22 of the stock control apparatus 20 or features from the stock configuration 32 of the stock control apparatus 30 for buffer-storing. To do this, the user can repeat steps 112 to 116 as often as desired.

It is also possible to add additional features to the buffer-stored features 62 at any other time. To do this, the user merely has to start the detection mode 111 with step 110 and can then perform the further steps of the selection 112 of a stock control apparatus 10, 20, 30, of opening 114 a stock configuration 12, 22, 32 of a stock control apparatus 10, 20, 30, and selecting and buffer-storing 116 at least one feature from the stock configuration 12, 22, 32.

After all features 62 of the stock configurations 12, 22, 32 to be transferred are available in the buffer-store 60, they can be transferred to the corresponding target control apparatus 40, 50 in a transfer mode 121.

For this purpose, the user can start the transfer mode 121 in step 120 and select at least one target control apparatus 40, 50 in step 122, to which the features are to be transferred. The target control apparatus 40, 50 can be a newly projected or initialized control apparatus, or one of the target control apparatuses 40, 50 of a network that has already been detected or implemented in the scan step. Thereafter, in step 124, the selected and buffer-stored features 62 of the stock configuration 12, 22, 32 are transferred to the target control apparatus 40, 50. In the selected target control apparatus 40, 50, the features are entered at the appropriate place in the target configuration 42, 52 and stored locally in the memory.

The user can also select multiple target control apparatuses 40, 50 in step 122, for example, the target control apparatuses 40 and the target control apparatuses 50. Then, in step 124, the buffer-stored features of the stock configuration 12, 22, 32 are transferred to each of the target configurations 42, 52 of the selected target control apparatuses 42, 52 and stored there locally in the respective memory.

Alternatively, the user can perform steps 120 or 112 through 124 of the transfer mode 121, also repeatedly, for multiple target control apparatuses 40, 50, for example, at a later stage in the engineering process, as illustrated by the arrow 125.

The transfer of the at least one selected and buffer-stored feature of the stock configuration(s) 12, 22, 32 to the target control apparatus(s) 40, 50 is also possible if the target control apparatus 40, 50 or target control apparatuses 40, 50 are located in another network than the stock control apparatuses 10, 20, 30.

In step 123, it is preferred for the selected and buffer-stored features 62 to be displayed to the user before transferring the features to the target control apparatus 40, 50. This is preferably done in a window of the engineering program. This allows for the user to select in a targeted manner which features from the buffer-stored features in step 126 are to be transferred to the target configuration 42, 52, for example, by setting a check mark or otherwise selecting them.

In addition, in step 128, the user is given the option of manually changing the features 62 to be transferred and buffer-stored. This can be used to customize the configuration of the corresponding target control apparatus 40, 50 before the transfer.

After the selected features have been determined, they are transferred to the target configuration 42, 52 of the target control apparatus 40, 50 in step 124. For this purpose, the corresponding data 44, 54 are uploaded to the corresponding target control apparatus 40, 50 and stored in the appropriate place in the memory.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to configure an industrial control apparatus, the method comprising:
starting a detection mode;
selecting a stock control apparatus;
opening a stock configuration of the stock control apparatus;
selecting and buffer-storing at least one feature from the stock configuration;
starting a transfer mode;
selecting at least one target control apparatus; and
transferring the at least one selected and buffer-stored feature of the stock configuration to the target control apparatus.

2. The method for configuring an industrial control apparatus according to claim 1, wherein the step of starting the detection mode involves scanning one or more networks for stock control apparatuses and / or for target control apparatuses.

3. The method for configuring an industrial control apparatus according to claim 2, wherein the stock control apparatuses and / or the target control apparatuses are located in a common network or in multiple different networks.

4. The method for configuring an industrial control apparatus according to claim 1, further comprising: ending the detection mode.

5. The method for configuring an industrial control apparatus according to claim 1, wherein the steps of starting a detection mode, selecting a stock control apparatus, opening a stock configuration of the stock control apparatus, and selecting and buffer-storing at least one feature from the stock configuration are repeated for more than one stock control apparatus in order to select features from different stock configurations of different stock control apparatuses.

6. The method according to claim 5, wherein the features from different stock configurations are transferred to the target control apparatus in a single transfer step.

7. The method for configuring an industrial control apparatus according to claim 1, wherein in the step of selecting at least one target control apparatus, more than one target control apparatus is selected, and wherein in the step of transferring the at least one selected and buffer-stored feature, the at least one selected and buffer-stored feature of the stock configuration is transferred to each of the selected target control apparatuses.

8. The method for configuring an industrial control apparatus according to claim 1, wherein the steps of selecting the at least one target control apparatus and the step of transferring are repeatedly performed for multiple target control apparatuses.

9. The method for configuring an industrial control apparatus according to claim 1, further comprising: displaying the selected feature or features.

10. The method for configuring an industrial control apparatus according to claim 9, wherein the step of displaying the selected features takes place before the transfer of the features to the target control apparatus.

11. The method for configuring an industrial control apparatus according to claim 10, wherein the step of displaying the selected features takes place after the step of selecting the at least one target control apparatus and before the step of transferring.

12. The method for configuring an industrial control apparatus according to claim 1, wherein after the step of selecting the at least one targe control apparatus and before the step of transferring, a step selecting the features to be transferred to the target control apparatus from the buffer-stored features is performed.

13. The method for configuring an industrial control apparatus according to claim 1, wherein after the step of selecting the at least one targe control apparatus and before the step of transferring, a step of manually changing the buffer-stored features is performed.

14. An apparatus to carry out the method according to claim 1.
